(19) United States
(12) Patent Application Publication
(10) Pub. No.: US 2015/0375819 A1
(43) Pub. Date: Dec. 31, 2015

(54) Motorcycle/ATV Driver Backrest Passenger Handle Bar

(71) Applicant: Robert Henbest, Westminster, TX (US)

(72) Inventor: Robert Henbest, Westminster, TX (US)

(21) Appl. No.: 14/318,718

(22) Filed: Jun. 30, 2014

(51) Int. Cl. B62J 1/28

(52) U.S. Cl. CPC B62J 1/28

(57) ABSTRACT

A passenger handle bar for a passenger of a motorcycle may include a support bracket to be connected to the motorcycle or passenger seat and a backrest for the driver of the motorcycle connected to the support bracket. The passenger handlebar may be connected to the support bracket or backrest.

### FIELD OF THE INVENTION

The present invention relates to a motorcycle and more particularly to a handle bar to be used by the passenger of the motorcycle/ATV.

### BACKGROUND

Motorcycle riding is an exciting and widespread recreation for all ages. At first, motorcycle riding was limited to a single user, but a need quickly arose for the ability to carry at least two users on the motorcycle. In order to facilitate this need, the motorcycle seat was extended in order to provide sufficient space for a second user or user of the motorcycle. In other circumstances, a second seat was provided directly behind the motorcycle driver.

The motorcycle driver may have a pair of handles which may include controls to operate the motorcycle and a place for the driver to position the driver's hands to provide stability while operating the motorcycle. However, the passenger seated behind the driver does not have access to the handles and consequently cannot achieve stability while riding the motorcycle. One way of achieving this stability is to hold on to the driver of the motorcycle. However, the driver of the motorcycle may be distracted by the hands of the passenger, and the passenger may not be able to obtain a firm grip resulting in an insecure ride.

### SUMMARY

A passenger handle bar for a passenger of a motorcycle may include a support bracket to be connected to the motorcycle and a backrest for the driver of the motorcycle connected to the support bracket.

The passenger handlebar may be connected to the support bracket.

The passenger handlebar may be hollow.

The passenger handlebar may be solid.

The passenger handlebar may be U-shaped.

The passenger handlebar may be linear/straight.

The passenger handlebar may be oval.

The passenger handlebar may be rectangular.

The passenger handlebar may be triangular.

The passenger handlebar may be trapezoid.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the passenger handle bar of the present invention;

FIG. 2 illustrates a back view of the passenger handle bar of the present invention;

FIG. 3 illustrates a perspective view of the passenger handle bar of the present invention;

FIG. 4 illustrates a another perspective view of the passenger handle bar of the present invention;

FIG. 5 illustrates a top view of the passenger handle bar of the present invention;

FIG. 6 illustrates a rear view of the passenger handle bar of the present invention;

FIG. 7 illustrates a top view of the passenger handle bar of the present invention;

FIG. 8 illustrates a rear view of the passenger handle bar of the present invention;

FIG. 9 illustrates a top view of the passenger handle bar of the present invention;

FIG. 10 illustrates a rear view of the passenger handle bar of the present invention;

FIG. 11 illustrates a rear view of the passenger handle bar of the present invention;

FIG. 12 illustrates a top view of the passenger handle bar of the present invention;

FIG. 13 illustrates a rear view of the passenger handle bar of the present invention;

FIG. 14 illustrates a rear view of the passenger handle bar of the present invention;

FIG. 15 illustrates a rear view of the passenger handle bar of the present invention;

FIG. 16 illustrates a rear view of the passenger handle bar of the present invention;

FIG. 17 illustrates a rear view of the passenger handle bar of the present invention;

FIG. 18 illustrates a cross-sectional view of the passenger handle bar of the present invention;

FIG. 19 illustrates another cross-sectional view of the passenger handle bar of the present invention;

FIG. 20 illustrates a side view of a passenger handlebar for a ATV of the present invention.

### DETAILED DESCRIPTION

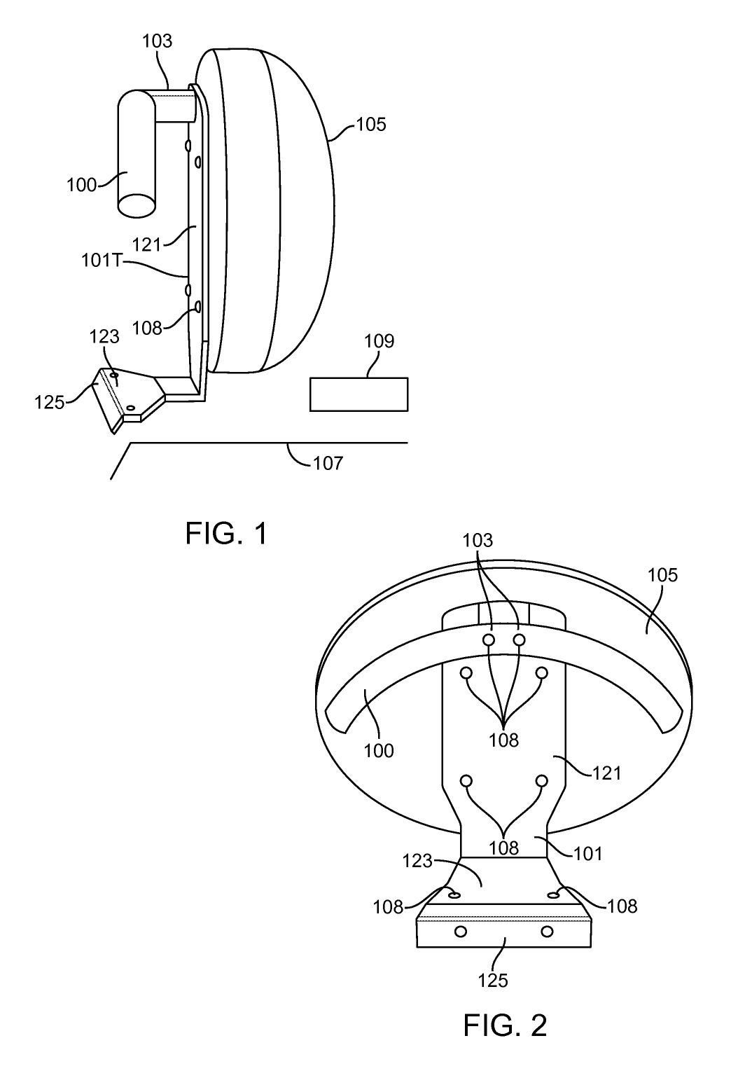

FIG. 1 illustrates a side perspective view of the passenger handle bar 100 of the present invention, and FIG. 1 additionally illustrates a support bracket 101 which may be connected to standoff arms 103 which may be connected to the passenger handle bar 100. The standoff arms 103 may position the passenger handle bar 100 in a spaced relationship to the support bracket 101 to allow the hands of the passenger sufficient space from the support bracket 101 to wrap around the passenger handle bar 100.

The support bracket 101 may be connected to a backrest pad 105 for the driver of the motorcycle 107 and may be adjacent to a seat 109 for the driver of the motorcycle 107.

The passenger handle bar 100 may be hollow or solid, may be flexible or rigid, and may be formed from metal, plastic or other appropriate material.

FIG. 18 illustrates that the passenger handle bar 100 may have a substantially circular cross-section, and FIG. 19 illustrates that the passenger handle bar 100 may have a rectangular cross-section. Other cross-section shapes are within the scope of the present invention.

The support bracket 101 may connect to the motorcycle 107 by fasteners 108 which may be threaded screws, bolts or other fastening devices and may include a backrest portion 121 to connect to the backrest pad, may include a horizontal portion 123 to connect to the motorcycle 107 and may include a inclined portion 125 to connect to the motorcycle 107. Other embodiments may vary the design of the horizontal portion 123 and the inclined portion 125 or may not include these portions.

FIG. 2 illustrates a back view of the passenger handle bar 100 of the present invention, and FIG. 2 additionally illustrates a support bracket 101 which may be connected to standoff arms 103 or standoff bracket which may be connected to the passenger handle bar 100. The standoff arms 103 may position the passenger handle bar 100 in a spaced relationship to the support bracket 101 to allow the hands of the passenger sufficient space from the support bracket 101 to wrap around the passenger handle bar 100.

The support bracket 101 may be connected to a backrest pad 105 for the driver of the motorcycle 107 and may be adjacent to a seat 109 for the driver of the motorcycle 107.

The support bracket 101 may connect to the motorcycle 107 by fasteners 108 which may be threaded screws, bolts or other fastening devices and may include a backrest portion 121 to connect to the backrest pad, may include a horizontal portion 123 to connect to the passenger seat of the motorcycle 107 and may include a inclined portion 125 to connect to the motorcycle 107.

The passenger handle bar 100 may be hollow or solid, may be flexible or rigid, and may be formed from metal, plastic or other appropriate material.

FIG. 4 illustrates a back perspective view of the passenger handle bar 100 of the present invention, and FIG. 4 additionally illustrates a support bracket 101 which may be connected to standoff arms 103 which may be connected to the passenger handle bar 100. The standoff arms 103 may position the passenger handle bar 100 in a spaced relationship to the support bracket 101 to allow the hands of the passenger sufficient space from the support bracket 101 to wrap around the passenger handle bar 100.

The support bracket 101 may be connected to a backrest pad 105 for the driver of the motorcycle 107 and may be adjacent to a seat 109 for the driver of the motorcycle 107.

The support bracket 101 may connect to the motorcycle 107 by fasteners 108 which may be threaded screws, bolts or other fastening devices and may include a backrest portion 121 to connect to the backrest pad, a horizontal portion 123 to connect to the passenger seat of the motorcycle 107 and may include a inclined portion 125 to connect to the motorcycle 107.

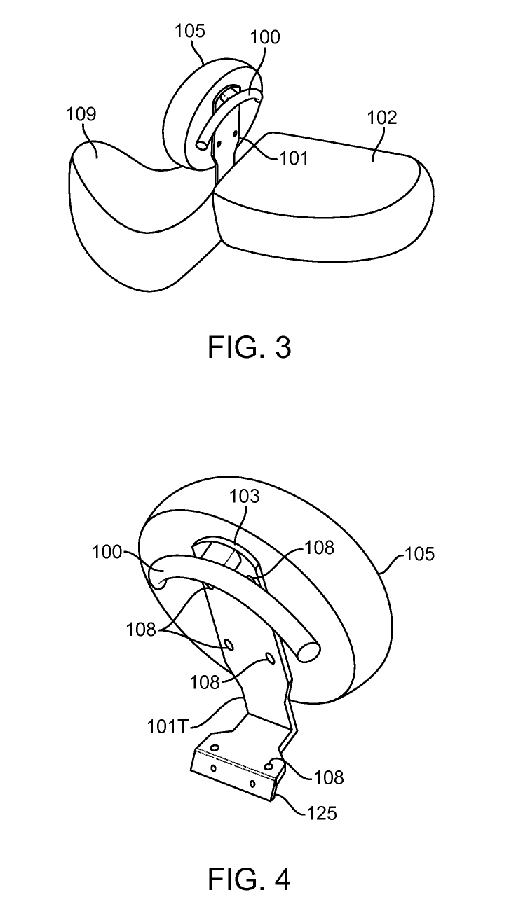

FIG. 3 illustrates a perspective view of the passenger handle bar 100 of the present invention, and the passenger handle bar 100 may be connected to the support bracket 101 which may be connected to a passenger seat 102 by fasteners. The support bracket 101 may be connected to the back rest pad 105 and may be adjacent to the seat 109.

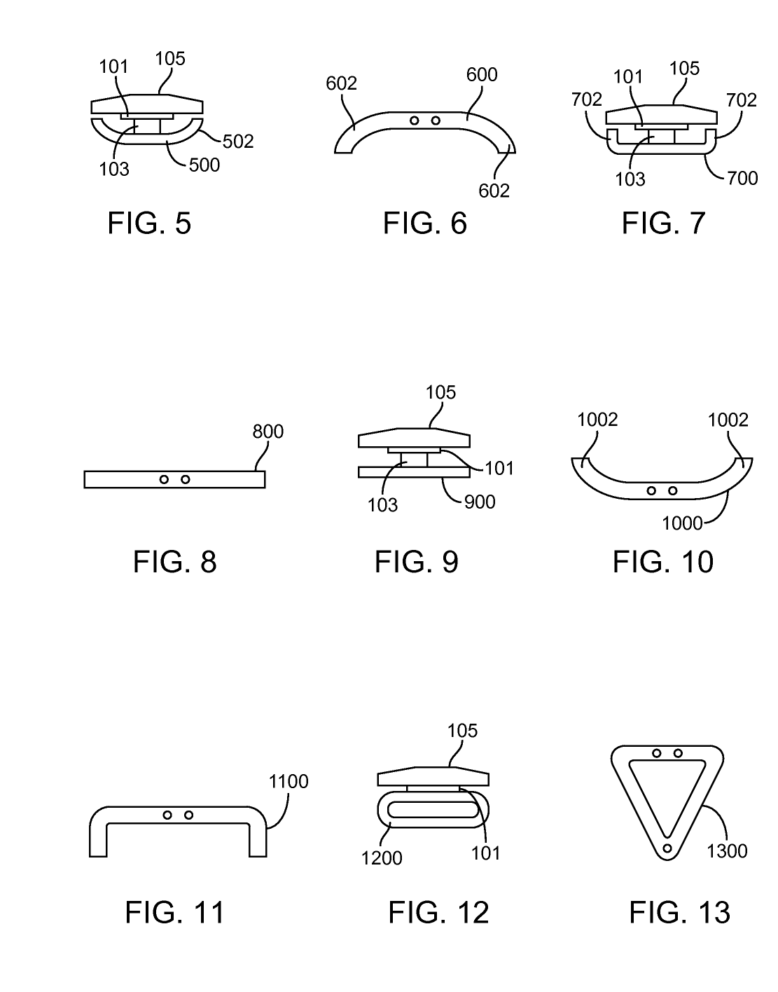

FIGS. 5-17 illustrates various alternative shapes for the passenger handle bar 100 of the present invention.

FIG. 5 illustrates the backrest pad 105 mounted on the support bracket 101 and a standoff arm 103 which may be connected to the support bracket 101. The passenger handle bar 500 may be connected to the standoff arm 103 and may include a pair of inward curved portions 502.

FIG. 7 illustrates the backrest pad 105 mounted on the support bracket 101 and a standoff arm 103 which may be connected to the support bracket 101. The passenger handle bar 700 may be U shaped and may be connected to the standoff arm 103 and may include a pair of inward curved portions 702.

FIG. 9 illustrates the backrest pad 105 mounted on the support bracket 101 and a standoff arm 103 which may be connected to the support bracket 101. The passenger handle bar 900 may be substantially linear/straight and may be connected to the standoff arm 103.

FIG. 12 illustrates the backrest pad 105 mounted on the support bracket 101. The passenger handle bar 1200 may be substantially oval and may be connected to the support bracket 101.

FIG. 6 illustrates the passenger handle bar 600 having a pair of opposing curved arms 602.

FIG. 8 illustrates the passenger handle bar 800 which may be substantially linear/straight.

FIG. 10 illustrates the passenger handle bar 1000 which may include a pair of opposing curved arms 1002.

FIG. 11 illustrates the passenger handle bar 1100 which may be substantially U shaped.

FIG. 13 illustrates the passenger handle bar 1300 which may be substantially a triangular shape.

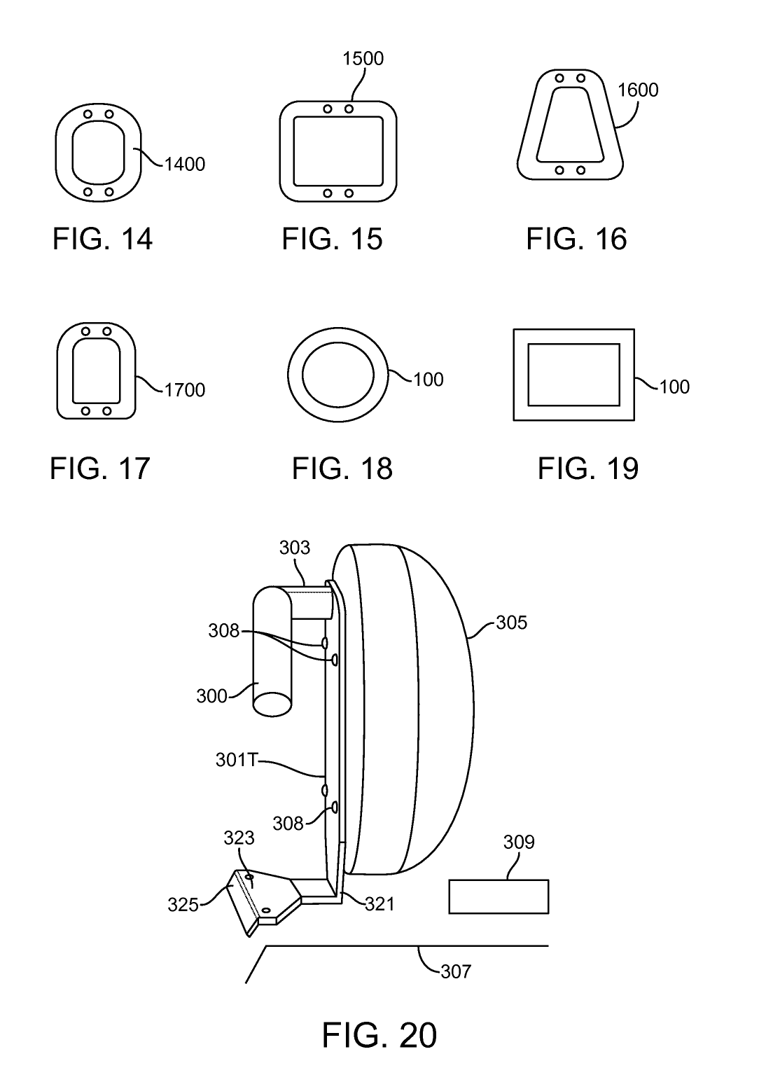

FIG. 14 illustrates the passenger handle bar 1400 which may be substantially oval/circular in shape.

FIG. 15 illustrates the passenger handle bar 1500 which may be substantially rectangular in shape.

FIG. 16 illustrates the passenger handle bar 1600 which may be substantially trapezoid in shape.

FIG. 17 illustrates the passenger handle bar 1700 which may be substantially rectangular having a pair of opposing rounded corners and a pair of substantially perpendicular corners.

The support bracket 101 of the present invention may be common to support the backrest pad 105 of the motorcycle driver and the passenger handle bar of the present invention.

The above teachings of the present invention are equally applicable to an all-terrain vehicle (ATV). FIG. 20 illustrates a side perspective view of the passenger handle bar 300 for the all-terrain vehicle of the present invention, and FIG. 20 additionally illustrates a support bracket 301 for the all-terrain vehicle which may be connected to standoff arms 303 which may be connected to the passenger handle bar 300. The standoff arms 303 may position the passenger handle bar 300 in a spaced relationship to the support bracket 301 to allow the hands of the passenger sufficient space from the support bracket 301 to wrap around the passenger handle bar 300.

The support bracket 301 may be connected to a backrest pad 305 for the driver of the ATV 307 and may be adjacent to a seat 309 for the driver of the ATV 307.

The passenger handle bar 300 may be hollow or solid, may be flexible or rigid, and may be formed from metal, plastic or other appropriate material.

The support bracket 301 may connect to the ATV 307 by fasteners 308 which may be threaded screws, bolts or other fastening devices and may include a backrest portion 321 to connect to the backrest pad 305, may include a horizontal portion 323 to connect to the passenger seat 302 of the ATV 307 and may include a inclined portion 325 to connect to the ATV 307.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A passenger handle bar for a passenger of a motorcycle, comprising:
a support bracket to be connected to the motorcycle;
a backrest for the driver of the motorcycle connected to the support bracket;
the passenger handlebar being connected to the support bracket.

2) A passenger handle bar for a passenger of a motorcycle as in claim 1, wherein the passenger handle bar is hollow.

3) A passenger handle bar for a passenger of a motorcycle as in claim 1, wherein the passenger handle bar is solid.

4) A passenger handle bar for a passenger of a motorcycle as in claim 1, wherein the passenger handle bar is U-shaped.

5) A passenger handle bar for a passenger of a motorcycle as in claim 1, wherein the passenger handle bar is linear/straight.

6) A passenger handle bar for a passenger of a motorcycle as in claim 1, wherein the passenger handle bar is oval.

7) A passenger handle bar for a passenger of a motorcycle as in claim 1, wherein the passenger handle bar is rectangular.

8) A passenger handle bar for a passenger of a motorcycle as in claim 1, wherein the passenger handle bar is triangular.

9) A passenger handle bar for a passenger of a motorcycle as in claim 1, wherein the passenger handle bar is trapezoid.

10) A passenger handle bar for a passenger of an all-terrain vehicle, comprising:
a support bracket to be connected to passenger seat of the all-terrain vehicle;
a backrest for the driver of the all-terrain vehicle connected to the passenger handlebar;
the passenger handlebar being connected to the backrest.

11) A passenger handle bar for a passenger of an all-terrain vehicle as in claim 10, wherein the passenger handle bar is hollow.

12) A passenger handle bar for a passenger of an all-terrain vehicle as in claim 10, wherein the passenger handle bar is solid.

13) A passenger handle bar for a passenger of an all-terrain vehicle as in claim 10, wherein the passenger handle bar is U-shaped.

14) A passenger handle bar for a passenger of an all-terrain vehicle as in claim 10, wherein the passenger handle bar is linear/straight.

15) A passenger handle bar for a passenger of an all-terrain vehicle as in claim 10, wherein the passenger handle bar is oval.

16) A passenger handle bar for a passenger of an all-terrain vehicle as in claim 10, wherein the passenger handle bar is rectangular.

17) A passenger handle bar for a passenger of an all-terrain vehicle as in claim 10, wherein the passenger handle bar is triangular.

18) A passenger handle bar for a passenger of an all-terrain vehicle as in claim 10, wherein the passenger handle bar is trapezoid.

19) A passenger handle bar for a passenger of an all-terrain vehicle, comprising:
a support bracket to be connected to passenger seat of the all-terrain vehicle;
a backrest for the driver of the all-terrain vehicle connected to the passenger handlebar;
the passenger handlebar being connected to the backrest.

20) A passenger handle bar for a passenger of a motorcycle, comprising:
a support bracket to be connected to passenger seat of the motorcycle;
a backrest for the driver of the motorcycle connected to the passenger handlebar;
the passenger handlebar being connected to the backrest.
